(19) United States
(12) Patent Application Publication
(10) Pub. No.: US 2026/0168932 A1
(43) Pub. Date: Jun. 18, 2026

(54) BUBBLE-RESISTANT FLUOROPOLYMER-FREE SENSOR MEMBRANE, SENSOR SPOT CONTAINING THE SENSOR MEMBRANE, SENSOR CAP CONTAINING THE SENSOR SPOT, AND SENSOR CONTAINING THE SENSOR CAP

(71) Applicant: Endress+Hauser Conducta GmbH+Co. KG, Gerlingen (DE)

(72) Inventors: Erik Hennings, Freiberg (DE); Andreas Löbbert, Waldheim (DE)

(21) Appl. No.: 19/421,068

(22) Filed: Dec. 16, 2025

(30) Foreign Application Priority Data
Dec. 16, 2024 (DE) 10 2024 138 072.1

(51) Int. Cl. G01N 21/76; C08J 7/04; C08K 5/00; C08L 23/06; C08L 71/10; C08L 81/04; C08L 81/06; C09D 123/06; C09D 171/10; C09D 181/04; C09D 181/08

(52) U.S. Cl. CPC G01N 21/766; C08J 7/042; C08K 5/0041; C08L 23/06; C08L 71/10; C08L 81/04; C08L 81/06; C09D 123/06; C09D 171/10; C09D 181/04; C09D 181/08; C08J 2323/06; C08J 2371/10; C08J 2381/04; C08J 2381/06; C08L 2207/068; G01N 2201/0227

(57) ABSTRACT

A method for producing a sensor spot coated with a fluoropolymer-free polymer layer includes coating a substrate with an analyte-sensitive pigment layer arranged on the medium side. The pigment layer contains at least one luminophoric dye and is designed to emit luminescence. The intensity, decay time, or phase shift of the luminescence depends upon the concentration of the analyte. The method also includes coating the pigment layer with a first silicone layer arranged on the medium side, and coating the first silicone layer with a fluoropolymer-free polymer layer that comprises ultra-high molecular weight polyethylene (UHMPE), polyether ether ketone (PEEK), polysulfone (PSU), and polyphenylene sulfide (PPS).

### CROSS-REFERENCE TO RELATED APPLICATION

The present application is related to and claims the priority benefit of German Patent Application No. 10 2024 138 072.1, filed on Dec. 16, 2024, the entire contents of which are incorporated herein by reference.

### TECHNICAL FIELD

The present disclosure relates to a fluoropolymer-free sensor membrane or a sensor spot, a sensor cap containing the sensor membrane, and a sensor containing the sensor cap.

### BACKGROUND

Optical sensors are sensors that are based upon an optochemical reaction with an analyte in a measuring medium. An optochemical analyte sensor, e.g., an oxygen sensor or carbon dioxide sensor, is based upon the principle of analyte-induced luminescence quenching of an indicator, in particular an organic luminescent dye or fluorescent or phosphorescent dye, tailored to a given analyte, which is usually incorporated into a polymer matrix. The sensor unit of such a sensor contains in particular a sensor membrane or a sensor spot comprising a substrate, e.g., a glass plate or an optical fiber, onto which the polymer/dye mixture tailored to a given analyte is applied as a solid film. The respective underlying measurement principles are known from a multitude of publications. Corresponding sensors are produced and marketed by the applicant in the most varied embodiments.

Gaseous analytes such as oxygen are for example introduced using a sparger in biotechnological fermentation processes, e.g., in the production of biologics, in order to achieve higher cell densities and therefore increase the product yield. Gas distributors of different geometries that are used to introduce gases into process environments or reaction vessels are termed spargers. A sparger is often located at the bottom of the reaction vessel, in the vicinity of the agitator or as a unit with the agitator. Sensors, on the other hand, can be installed at various locations in the reaction vessel. Common installation positions for sensors are, inter alia, from above through the cover or end plate of the reaction vessel, or from the side through the wall of the reactor vessel. A sensor is often inserted into the reaction vessel via a flange located on the reaction vessel, wherein the sensor is inserted into the reaction vessel directly or in the interior of a so-called sensor fitting, depending upon the design. In the case of the fermenter, for example, the sparger introduces air or oxygen bubbles into the aqueous measuring medium located therein and distributes them throughout the fermenter, in particular in the measuring medium, with the help of the agitator. These gas bubbles can have different sizes and, as already mentioned, accumulate on the optical sensor and/or the sensor element and cause error values-for example, due to measuring peaks, incorrect measurements, and/or even overloads.

There are currently few sensor caps for optical sensors that show a bubble-resistant effect in fermenters. Both the surface finish as well as the geometry of the sensor cap can positively affect the bubble-resistant effect.

Previous solutions describe a PTFE layer in front of a sensor spot in a sensor cap, wherein the cap is registered as utility model DE202015009426U1. For example, DE202015009426U1 discloses a PTFE layer that is applied to a sensor spot. The sensor cap containing the sensor spot has a slope of 30° to the front surface, and the sensor spot is glued between the front surface of the sensor cap and a threaded part. The gaps between the sensor spot and the metal wall are greatly reduced due to the small thickness of the slightly hydrophilic stainless steel wall. The cap geometry is therefore enhanced in terms of flow dynamics.

PTFE is a polytetrafluoroethylene and therefore belongs to the per- and polyfluorinated alkyl compounds (PFAS). PFAS and their degradation products are very persistent in the environment and are therefore also called perennial chemicals: PFAS are not completely degradable under environmental conditions or only completely degradable over very long periods of time. Certain PFAS are toxic to humans and animals and are suspected of causing cancer and numerous other health effects. In the body, perfluorinated surfactants accumulate in the blood and organ tissue and are excreted only slowly.

### SUMMARY

The object according to the present disclosure is to provide an improved bubble-resistant sensor cap that does not require the use of fluoropolymers and is therefore significantly more environmentally friendly.

In the sense of the present disclosure, a sensor spot is provided which differs from the sensor spot according to the prior art by a PTFE-free coating. This has the advantage that a large number of caps that contain sensor spots can be manufactured modularly according to the modular principle. Furthermore, the present disclosure provides an improved cap containing the sensor spot, in which the sealing ring is covered by the cap sleeve and is not in contact with the medium during operation.

The present disclosure relates to a method for producing a sensor spot coated with a polymer cover layer including providing a substrate, such as a glass substrate, or more particularly a glass substrate made of quartz glass, and coating the substrate with an analyte-sensitive pigment layer arranged on the medium side. The pigment layer contains at least one luminophoric dye and is designed to emit luminescence, where the intensity, decay time, or phase shift of the luminescence depends upon the concentration of the analyte. The method also includes coating the pigment layer with a first silicone layer arranged on the medium side, and coating the first silicone layer with a fluoropolymer-free polymer layer. The fluoropolymer-free polymer layer comprises ultra-high molecular weight polyethylene (UHMPE), polyether ether ketone (PEEK), polysulfone (PSU), and polyphenylene sulfide (PPS), or consists of one of these fluoropolymer-free polymers, preferably polyether ether ketone (PEEK).

In one embodiment, the fluoropolymer-free polymer layer of the sensor spot, which has a layer thickness of 0.1 to 20 μm, is covered by a metal grid on the surface facing the medium during operation, wherein the metal grid has a mesh width of 0.1 mm or less than 0.1 mm, preferably 5-100 μm, more preferably 25 μm. The metal grid preferably consists of steel, more preferably 1.4401 steel. The metal wires of the metal grid have a diameter of less than 0.1 mm, wherein the diameter of the metal wires is smaller than the mesh width of the metal grid. The diameter depends upon the mesh width and is therefore less than 0.1 mm, preferably less than 5-100 μm, more preferably less than 25 μm.

In one embodiment, the metal grid is designed to be pressed, such as pressed without a gap, between the side, touching the medium during operation, of the sensor spot and the inside of the sleeve-shaped outer component on the side, touching the medium during operation, which covers the sensor spot at the edge region.

In one embodiment, the coating comprises covering the silicone layer of the sensor spot on the surface facing the medium during operation with a fabric comprising a fluoropolymer-free polymer or consisting of a fluoropolymer-free polymer which comprises a lattice structure or consists of a lattice. The fabric has a layer thickness or fabric thickness between 50 and 80 μm, preferably a fabric thickness of 62 μm (+/−7%). Preferably, the fabric has a mesh width of 36 μm +/−7%, an open area of 24%+/−7%, and a thread diameter of 35 μm. In a preferred embodiment, the fabric comprises a mesh opening of 35 μm, an open area of 22%, and a fabric thickness of 70 μm. Preferably, the fluoropolymer-free polymer comprises PEEK or consists thereof.

The advantage of the present disclosure is that a sensor spot according to the present disclosure coated with a fluoropolymer-free polymer layer is provided, in which the accumulation of gas bubbles, e.g., air and/or oxygen gas bubbles, is reduced, and therefore a less noisy signal from the sensor is attained during the measurement, in particular during the measurement of a gas, such as the O₂ gas.

The polymer layer according to the present disclosure is chemically resistant, in particular to acids and bases, and temperature-stable up to a temperature of 140° C. The analyte permeability of the fluoropolymer-free polymer layer is of the same order of magnitude as that of PTFE.

In one embodiment, the fluoropolymer-free polymer layer is the layer contacting the medium during operation.

In one embodiment of the present disclosure, the method comprises the step of applying a second silicone layer to the substrate prior to applying the pigment layer.

In one embodiment, the present disclosure relates to a method for producing a sensor spot coated with a fluoropolymer-free polymer layer, including providing a substrate, such as a glass substrate or a glass substrate made of quartz glass, and coating the substrate on the medium side with an analyte-sensitive pigment layer, wherein the pigment layer contains at least one luminophoric dye, wherein the pigment layer is designed to emit luminescence, wherein the intensity, decay time, or phase shift of the luminescence depends upon the concentration of the analyte. The method also includes coating the analyte-sensitive pigment layer on the medium side with a reflector layer, which contains TiO₂, coating the analyte-sensitive pigment layer on the medium side or coating the reflector layer on the medium side with an optical insulation layer, wherein the optical insulation layer comprises silicone or consists of silicone, which comprises soot particles or iron oxide, and coating the analyte-sensitive pigment layer, the analyte-sensitive reflector layer on the medium side, or the optical insulation layer on the medium side with a first silicone layer. The method also includes coating the first silicone layer on the medium side with a fluoropolymer-free polymer layer, wherein the fluoropolymer-free polymer layer comprises ultra-high molecular weight polyethylene (UHMPE), polyether ether ketone (PEEK), polysulfone (PSU), and polyphenylene sulfide (PPS), preferably polyether ether ketone (PEEK), or consists of one of the polymers ultra-high molecular weight polyethylene (UHMPE), polyether ether ketone (PEEK), polysulfone (PSU), and polyphenylene sulfide (PPS), preferably polyether ether ketone (PEEK).

In one embodiment, the aforementioned method further comprises the steps of applying a second silicone layer to the substrate before applying the pigment layer, applying a third silicone layer to the pigment layer before applying a reflector layer and/or applying a fourth silicone layer to the reflector layer before applying an optical isolation layer.

The application takes place on the side facing the medium during operation.

In one embodiment, the coating is carried out by bonding the fluoropolymer-free polymer, which is formed as a polymer film, by pressing it onto the first silicone layer, arranged on the medium side, opposite the pigment layer.

In one embodiment of the method in which a polymer film is pressed onto the silicone layer, a layer thickness of the fluoropolymer-free polymer layer touching the media during operation of 0.1 μm-20 μm, preferably 0.1-10 μm, is obtained.

In a preferred embodiment, the coating is carried out by applying a dispersion containing the ultrafine polymer powder, preferably an aqueous dispersion, to the first silicone layer, wherein the application comprises spray coating, wherein the ultrafine polymer powder has particles with a particle diameter of 20 μm or smaller, preferably 0.01-20 μm, more preferably 0.1 to 20 μm, even more preferably 0.1 to 10 μm.

In one embodiment, the fluoropolymer-free polymer is then heated to a glass transition temperature of the respective polymer.

In one embodiment, the fluoropolymer-free polymer layer is treated with an acid, wherein the acid is selected from sulfuric acid or phosphoric acid, preferably from concentrated sulfuric acid or concentrated phosphoric acid, wherein the fluoropolymer-free polymer layer is heated to a glass transition temperature before or after the treatment with acid, wherein preferably the treatment with acid takes place after heating to the glass transition temperature. The treatment takes place over a period of at least 2 hours at a temperature of over 40° C.

The heating time depends upon the amount of particles and the diameter of the particles. Typical temperatures and heating times are known to a person skilled in the art.

In one embodiment of the method according to the present disclosure or an embodiment thereof in which the fluoropolymer-free polymer layer is the layer touching the medium during operation, the coating comprises applying a fluoropolymer-free polymer grid, preferably comprising or consisting of PEEK.

In one embodiment of the aforementioned method, the fluoropolymer-free polymer grid has a layer thickness or fabric thickness between 50 and 80 μm. Preferably, the fabric comprises a mesh width of 36 μm+/−7%, an open area of 24%+/−7%, a thread diameter of 35 μm, and a fabric thickness of 62 μm (+/−7%). In a preferred embodiment, the fabric comprises a mesh opening of 35 μm, an open area of 22%, and a fabric thickness of 70 μm. Preferably, the polymer PEEK comprises or consists of this material.

The present disclosure further relates to a sensor membrane for analyzing an analyte present in a medium, comprising a fluoropolymer-free polymer layer, wherein the fluoropolymer-free polymer layer consists of a polymer or comprises a polymer that is selected from an ultra-high molecular weight polyethylene (UHMPE), polyether ether ketone (PEEK), polysulfone (PSU), and polyphenylene sulfide (PPS), preferably polyether ether ketone (PEEK).

In a preferred embodiment, the polymer layer has a layer thickness of 0.1 μm-20 μm.

The sensor membrane according to the present disclosure or an embodiment thereof is comprised of an optical or electrochemical sensor.

The present disclosure further relates to a sensor spot coated with a fluoropolymer-free polymer layer and having a convex-shaped surface, facing the medium during operation, for an optical sensor for measuring an analyte in a measuring medium comprising the layers: a substrate facing away from the medium during operation, which is preferably a glass substrate, more preferably a glass substrate made of quartz glass; an analyte-sensitive pigment layer, arranged on the medium side, opposite the glass substrate, wherein the pigment layer contains at least one luminophoric dye, wherein the intensity, decay time, or phase shift of the luminescence of the luminophoric dye is designed to depend upon the concentration of the analyte; a first silicone layer, arranged on the medium side, opposite the analyte-sensitive pigment layer; and a fluoropolymer-free polymer layer arranged on the medium side on the first silicone layer, wherein the fluoropolymer-free polymer layer comprises ultra-high molecular weight polyethylene (UHMPE), polyether ether ketone (PEEK), polysulfone (PSU), and polyphenylene sulfide (PPS), preferably polyether ether ketone (PEEK), or consists of one of the polymers: ultra-high molecular weight polyethylene (UHMPE), polyether ether ketone (PEEK), polysulfone (PSU), and polyphenylene sulfide (PPS).

In one embodiment of the aforementioned sensor spot, the fluoropolymer-free polymer layer is designed as a fluoropolymer-free polymer grid arranged on the medium side on the first silicone layer, wherein the polymer comprises ultra-high molecular weight polyethylene (UHMPE), polyether ether ketone (PEEK), polysulfone (PSU), and polyphenylene sulfide (PPS), preferably polyether ether ketone (PEEK), or the polymer consists of one of these materials, preferably polyether ether ketone (PEEK).

In one embodiment of the aforementioned sensor spot, the fluoropolymer-free polymer layer, which is formed as a grid, comprises a fabric, or the fluoropolymer-free polymer layer consists of a fabric. The fabric has a layer thickness or fabric thickness between 50 and 80 μm. Preferably, the fabric comprises a mesh width of 36 μm+/−7%, an open area of 24%+/−7%, a thread diameter of 35 μm, and a fabric thickness of 62 μm (+/−7%). In a preferred embodiment, the fabric comprises a mesh opening of 35 μm, an open area of 22%, and a fabric thickness of 70 μm. Preferably, the polymer PEEK comprises or consists of this material.

In one embodiment, the sensor spot according to the present disclosure or an embodiment thereof that comprises a silicone layer as a fluoropolymer-free grid is obtained via a method according to the present disclosure or an embodiment of the method thereof, wherein the embodiment comprises a fluoropolymer-free gutter.

In another embodiment of the aforementioned sensor spot, the fluoropolymer-free polymer layer has a layer thickness of 0.1 μm-20 μm.

In one embodiment of the aforementioned sensor spot or an embodiment in which the fluoropolymer-free polymer layer has a layer thickness of 0.1 μm-20 μm, the fluoropolymer-free polymer layer is obtained by a method according to the present disclosure or an embodiment thereof in which a layer thickness of the fluoropolymer-free polymer layer is 0.1-20 μm.

In one embodiment, the fluoropolymer-free polymer layer has a layer thickness of 15-20 μm, a pore size between 5 and 100 nm, preferably 5, 20, or 100 nm, and preferably a porosity of 10%-60%. The pores are to be understood as pores passing through the fluoropolymer-free polymer layer.

In one embodiment, the sensor spot comprises the following layers: on the side facing away from the medium during operation, a substrate, preferably a glass substrate; an analyte-sensitive pigment layer, arranged on the medium side, opposite the glass substrate, wherein the pigment layer contains at least one luminophoric dye, wherein the pigment layer is designed to emit luminescence, wherein the intensity, decay time, or phase shift of the luminescence depends upon the concentration of the analyte, and, optionally a reflector layer, which comprises TiO₂, arranged on the medium side, opposite the analyte-sensitive pigment layer, and/or an optical insulation layer, arranged on the medium side, opposite the analyte-sensitive pigment layer or opposite the analyte-sensitive pigment layer and the reflector layer, wherein the optical insulation layer comprises silicone, which comprises soot particles or iron oxide; a first silicone layer, arranged on the medium side, opposite the analyte-sensitive pigment layer, opposite the analyte-sensitive pigment layer and the reflector layer, or opposite the analyte-sensitive pigment layer, the reflector layer, and the optical insulation layer; and a fluoropolymer-free polymer layer arranged on the medium side on the first silicone layer and touching the medium during operation, wherein the fluoropolymer-free polymer layer comprises ultra-high molecular weight polyethylene (UHMPE), polyether ether ketone (PEEK), polysulfone (PSU), and polyphenylene sulfide (PPS), preferably polyether ether ketone (PEEK), or consists of one of these fluoropolymer-free polymers, preferably polyether ether ketone (PEEK).

The present disclosure further relates to a sensor cap for an optochemical sensor for determining and/or monitoring at least one analyte present in a medium, containing: a cylindrical inner component containing a sensor spot coated with a cover layer according to the present disclosure or an embodiment thereof, and a sleeve-shaped outer component which borders the inner component and consists of stainless steel, preferably 1.4435 stainless steel, wherein the inner component and the outer component are detachably mechanically connected to one another, preferably via a first screw connection, wherein the sealing element, preferably an O-ring, is arranged, between the cylindrical inner component and the sleeve-shaped outer component, on the side touching the medium during operation, which sealing element is designed to seal the sensor against the measuring medium without a gap.

In the sense of the present disclosure, a sensor cap is provided which differs from the standard sensor cap by a fluoropolymer-free, preferably PTFE-free, coating. This has the advantage that other caps can be manufactured modularly according to the modular principle, in which already-used sensor spots can be replaced by new sensor spots. Alternatively, sensor spots with other material properties can be used.

In one embodiment of the sensor cap, the sealing element, preferably an O-ring, is completely covered by a sleeve-shaped outer component.

The present disclosure therefore provides an improved cap in which the sealing ring is not in contact with the medium during operation. During operation, the sealing element is therefore in indirect contact with the medium to be measured.

The present disclosure also provides an optical sensor for determining or monitoring at least one analyte present in a medium, wherein the sensor has a sensor cap according to the present disclosure or an embodiment thereof, and an electronics component, which are detachably connected to one another, wherein the electronics component consists of a first module having a light source and a detector, and a second module having a transceiver.

In one embodiment, the sensor cap is detachably connected to the electronics component mechanically, preferably via a screw connection.

In one embodiment, the first and the second modules are connected to one another via a detachable plug connection unit, wherein the detachable plug connection unit is designed to transmit energy and/or data by means of a galvanically isolated, in particular inductive, interface, wherein the detachable plug connection unit is preferably a bayonet closure, wherein energy is transmitted unidirectionally from the second module to the first module, and data, in particular data on the analyte concentration, are transmitted bidirectionally between the first and the second modules.

The present disclosure also relates to an optical analysis system comprising an optical sensor according to the present disclosure or an embodiment thereof, wherein the second module of the optical sensor is electrically connected to a data processing unit via a connection.

All the embodiments of the device, the flow cell, the method, and the use described above can be combined with each other in each case, provided that this is technically possible.

### BRIEF DESCRIPTION OF THE DRAWINGS

The present disclosure is explained in more detail in the following description with reference to the exemplary embodiment shown in the drawing, in which:

FIG. 1 shows an embodiment of the sensor spot according to the present disclosure coated with a fluoropolymer-free polymer layer.

FIG. 2 shows a further embodiment of the sensor spot according to the present disclosure coated with a fluoropolymer-free polymer layer.

FIG. 3 shows a sensor cap containing the sensor cap according to the present disclosure or an embodiment thereof.

FIG. 4 shows the optical analysis system according to the present disclosure comprising the optical sensor.

### DETAILED DESCRIPTION

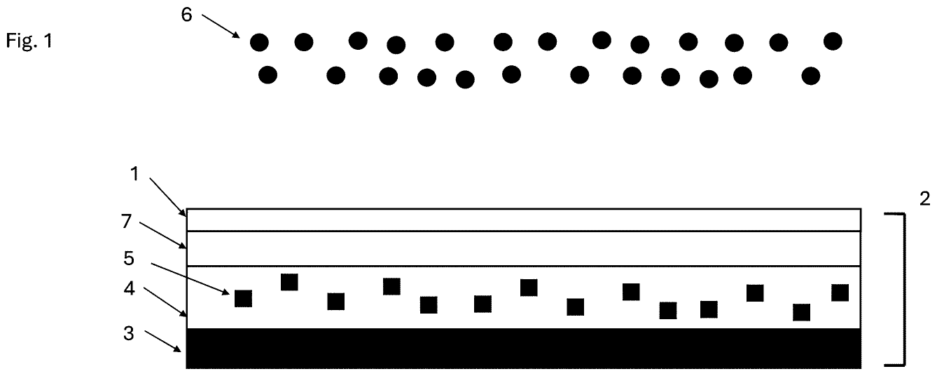

One embodiment of the sensor spot according to the present disclosure is illustrated in FIG. 1. FIG. 1 shows an embodiment of the sensor spot (2) according to the present disclosure containing a PTFE-free polymer layer (1) on the side facing the medium during operation. In the sensor spot (2) according to FIG. 1, the sensor layers are applied one over the other on a substrate (3), wherein the substrate (3), which preferably consists of quartz glass, is arranged on the side facing away from the medium during operation of the sensor. The analyte-sensitive pigment layer (4) containing the luminescent dye or the luminescent dye (5) is arranged on the medium side of the substrate (3). On the medium side of the analyte-sensitive pigment layer (4), a first silicone layer (7) is arranged which touches a fluoropolymer-free polymer layer during operation. On the medium side on the first silicone layer (7) touching the fluoropolymer-free polymer layer during operation, a fluoropolymer-free polymer layer (1) is arranged which is permeable to the analyte to be measured, but impermeable to the measuring medium (13) in which the analyte (6) is dissolved—for example, water. The fluoropolymer-free polymer layer (1) comprises or consists of a PTFE-free polymer layer, wherein the polymer layer is selected from: an ultra-high molecular weight polyethylene (UHMPE), polyether ether ketone (PEEK), polysulfone (PSU), and polyphenylene sulfide (PPS), preferably polyether ether ketone (PEEK). The fluoropolymer-free polymer layer (1) has a layer thickness of 0.1 μm-20 μm. The fluoropolymer-free polymer layer (1) is applied either by pressing or by applying an ultrafine polymer powder or a dispersion containing the ultrafine polymer powder, preferably an aqueous dispersion, to the first silicone layer (3), wherein the ultrafine polymer powder has a particle size of 20 μm or smaller, preferably 0.1-20 μm, more preferably 0.1 to 10 μm. The absolute pressure during spray coating is 1-4 bar.

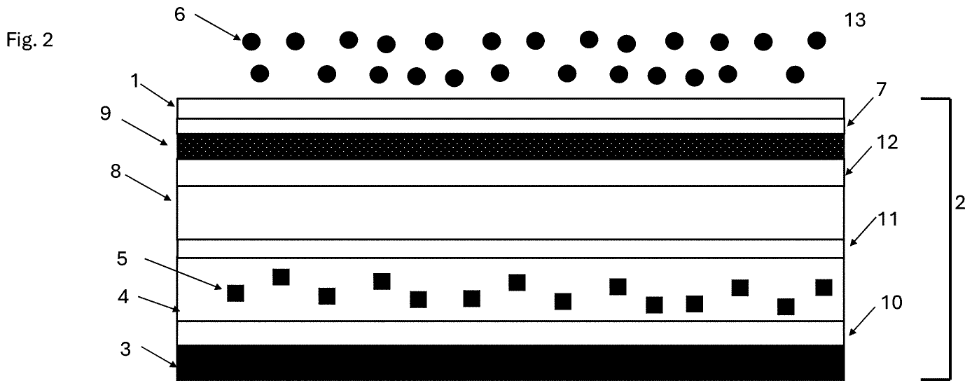

A further embodiment of the sensor according to the present disclosure is shown in FIG. 2. FIG. 2 shows an embodiment of the sensor spot (2) according to the present disclosure containing a PTFE-free polymer layer on the side facing the medium during operation. In the sensor spot (2) according to FIG. 2, the sensor layers are applied one above the other on a substrate (3), wherein the substrate (3), which preferably consists of quartz glass, is arranged on the side facing away from the medium during operation of the sensor. A second silicone layer (10) is arranged on the medium side of the substrate (3). An analyte-sensitive pigment layer (4) containing the luminescent dye (5) is arranged on the medium side of the second silicone layer (10). The third silicone layer (11) is arranged on the medium side of the analyte-sensitive pigment layer (4). A reflector layer (8) is arranged on the medium side of the third silicone layer (11). A fourth silicone layer (12) is arranged on the medium side of the reflector layer (8). An optical insulation layer (9) is arranged on the medium side of the fourth silicone layer (12). On the medium side of the optical insulation layer (9), a fluoropolymer-free polymer layer (1) is arranged which is permeable to the analyte to be measured, but impermeable to the measuring medium (13) in which the analyte (6) is dissolved—for example, water. The first silicone layer (7) touching the fluoropolymer-free polymer layer during operation is arranged between the fluoropolymer-free polymer layer (1) and the optical insulation layer (9).

The fluoropolymer-free polymer layer (1) preferably comprises a PTFE-free polymer layer, wherein the polymer layer comprises or consists of ultra-high molecular weight polyethylene (UHMPE), polyether ether ketone (PEEK), polysulfone (PSU), and polyphenylene sulfide (PPS), preferably polyether ether ketone (PEEK). The fluoropolymer-free polymer layer (1) has a layer thickness of 0.1 μm-20 μm. The application of the fluoropolymer-free polymer layer (1) is carried out either by pressing or by applying an ultrafine polymer powder or a dispersion containing the ultrafine polymer powder, preferably an aqueous dispersion, to the fluoropolymer-free, polymer layer-free sensor spot (3), wherein the application is a spray coating, wherein the ultrafine polymer powder has a particle size of 20 μm or smaller, preferably 0.01-20 μm, more preferably 0.1 to 20 μm, even more preferably 0.1 to 10 μm.

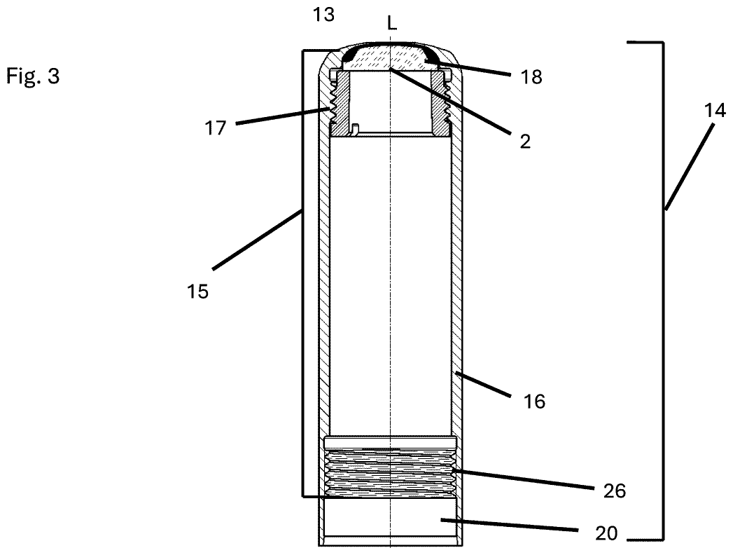

The sensor cap (14) of FIG. 3 comprises the sensor spot (2) from FIG. 1 or FIG. 2 according to the present disclosure coated with a fluoropolymer-free polymer layer. The sensor cap (14) consists of an inner component (15) which comprises the sensor spot according to the present disclosure or an embodiment (2) thereof, as well as a sleeve-like outer component (16). The inner component (15) and the outer component (16) are connected to each other via a detachable mechanical connection (18), wherein the mechanical connection preferably is a screw connection (17).

The sensor cap (14) is also connected to the electronics component (20) of the optical sensor (19) via a second detachable mechanical connection (27), preferably via a screw connection (17).

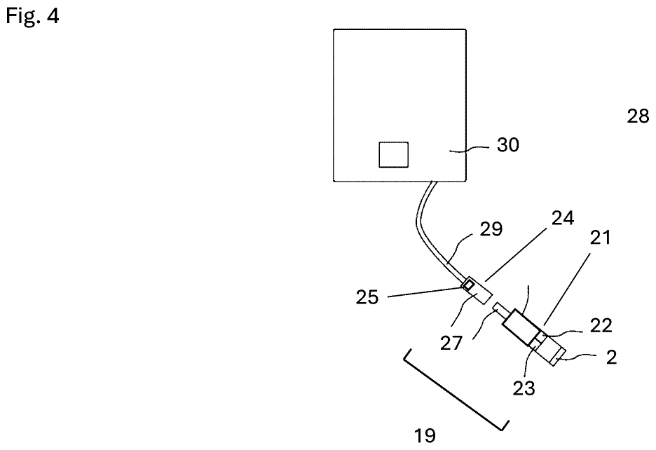

The sensor (19) according to FIG. 4 comprises the sensor cap (14) comprising the sensor spot (2) and the electronics component (20), wherein the electronics component (20) consists of a first module (21) comprising the light source (22) and the detector (24), and a second module (24) containing the transceiver (25). The first (21) and the second (24) modules are connected to one another via a mechanically detachable plug connection unit (27), wherein the mechanical plug connection unit (27) comprises an inductive interface. Preferably, the mechanical plug connection unit (27) comprises a bayonet closure. The sensor (19) is part of an optical analysis system (28), wherein the sensor (19) is connected to a data processing unit (30) via an electrical connection (29).

Reference signs are not to be understood as a limitation of the scope of the subject matter protected by the claims. They serve only the purpose of making the claims easier to understand.

1. A method for producing a sensor spot coated with a fluoropolymer-free polymer layer, comprising:
providing a substrate,
coating the substrate with an analyte-sensitive pigment layer arranged on the medium side, wherein the pigment layer contains at least one luminophoric dye, wherein the pigment layer is designed to emit luminescence, wherein the intensity, decay time, or phase shift of the luminescence depends upon the concentration of the analyte, coating the pigment layer with a first silicone layer arranged on the medium side,
coating the first silicone layer with a fluoropolymer-free polymer layer, wherein the fluoropolymer-free polymer layer comprises ultra-high molecular weight polyethylene (UHMPE), polyether ether ketone (PEEK), polysulfone (PSU), and polyphenylene sulfide (PPS).

2. The method according to claim 1, wherein the fluoropolymer-free polymer layer is the layer touching the medium during operation.

3. The method according to claim 1, wherein a layer thickness of the fluoropolymer-free polymer layer between 0.1 μm-20 μm is obtained.

4. The method according to claim 1, wherein the coating is carried out by bonding the fluoropolymer-free polymer, which is formed as a polymer film, by pressing it onto the first silicone layer, arranged on the medium side, opposite the pigment layer.

5. The method according to claim 1, wherein the coating is carried out by applying a dispersion containing the ultrafine polymer powder to the first silicone layer, wherein the application comprises spray coating, wherein the ultrafine polymer powder has particles with a particle diameter of 20 μm or smaller.

6. The method according to claim 5, wherein, after spray coating, the fluoropolymer-free polymer is heated to a glass transition temperature of the respective polymer.

7. The method according to claim 6, wherein the fluoropolymer-free polymer layer is treated with an acid, wherein the acid is selected from sulfuric acid or phosphoric acid, wherein the fluoropolymer-free polymer layer is heated to a glass transition temperature before or after the treatment with acid.

8. The method according to claim 1, wherein the coating comprises applying a fluoropolymer-free grid consisting of PEEK.

9. A sensor membrane for analyzing an analyte present in a medium, comprising a fluoropolymer-free polymer layer, wherein the fluoropolymer-free polymer layer consists of a polymer or comprises a polymer selected from an ultra-high molecular weight polyethylene (UHMPE), polyether ether ketone (PEEK), polysulfone (PSU), and polyphenylene sulfide (PPS).

10. A sensor spot coated with a fluoropolymer-free polymer layer and having a convex-shaped surface, facing the medium during operation, for an optical sensor for measuring an analyte in a measuring medium comprising the layers:
a glass substrate facing away from the medium during operation,
an analyte-sensitive pigment layer, arranged on the medium side, opposite the glass substrate, wherein the pigment layer contains at least one luminophoric dye, wherein the intensity, decay time, or phase shift of the luminescence of the luminophoric dye is designed to depend upon the concentration of the analyte,
a first silicone layer, arranged on the medium side, opposite the analyte-sensitive pigment layer,
a fluoropolymer-free polymer layer arranged on the medium side on the first silicone layer, wherein the fluoropolymer-free polymer layer comprises ultra-high molecular weight polyethylene (UHMPE), polyether ether ketone (PEEK), polysulfone (PSU), and polyphenylene sulfide (PPS), or consists of one of these fluoropolymer-free polymers.

11. The sensor spot according to claim 10, wherein the coating is carried out by bonding the fluoropolymer-free polymer, which is formed as a polymer film, by pressing it onto the first silicone layer, arranged on the medium side, opposite the pigment layer.

12. The sensor spot according to claim 10, wherein the coating is carried out by applying a dispersion containing the ultrafine polymer powder to the first silicone layer, wherein the application comprises spray coating, wherein the ultrafine polymer powder has particles with a particle diameter of 20 μm or smaller.

13. The sensor spot according to claim 10, wherein the sensor spot is coated with a fluoropolymer-free polymer layer, wherein the fluoropolymer-free polymer layer has a layer thickness of 0.1 μm-20 μm.

14. The sensor spot according to claim 10, wherein the sensor spot is coated with a fluoropolymer-free polymer layer, wherein the fluoropolymer-free polymer layer is formed as a fluoropolymer-free polymer grid arranged on the medium side on the first silicone layer, wherein
the polymer comprises ultra-high molecular weight polyethylene (UHMPE), polyether ether ketone (PEEK), polysulfone (PSU), and polyphenylene sulfide (PPS), or the polymer consists of one of these materials.

15. A sensor cap for an optochemical sensor for determining and/or monitoring at least one analyte present in a medium, containing:
a cylindrical inner component containing a sensor spot coated with a fluoropolymer-free polymer layer, and
a sleeve-shaped outer component which borders the inner component and is made of stainless steel, preferably 1.4435 stainless steel,
wherein the inner component and the outer component are detachably mechanically connected to one another, wherein the sealing element is arranged, between the cylindrical inner component and the sleeve-shaped outer component, on the side touching the medium during operation, which sealing element is designed to seal the sensor against the measuring medium without a gap.

16. The sensor cap according to claim 15, wherein the sealing element is completely covered by the sleeve-shaped outer component.

17. An optical sensor for determining or monitoring at least one analyte located in a medium, having a sensor cap according to claim 15, and an electronics component which are detachably connected to one another, wherein the electronics component consists of
a first module having a light source and a detector, and
a second module having a transceiver.
